(19) United States
(12) Patent Application Publication
(10) Pub. No.: US 2004/0136803 A1
(43) Pub. Date: Jul. 15, 2004

(54) Fastener for fiberglass and other composite structures

(76) Inventor: Gregory E. Grosch, Laguna Beach, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/724,560

(22) Filed: Nov. 26, 2003

Related U.S. Application Data
(60) Provisional application No. 60/429,870, filed on Nov. 27, 2002.
(60) Provisional application No. 60/508,143, filed on Oct. 1, 2003.

(51) Int. Cl. F16B 39/02

(52) U.S. Cl. 411/82

(57) ABSTRACT

A threaded fastener has a self-drilling tip and threads holding a microencapsulated, substantially dry, self-curing adhesive. The tip is distanced from the threads by at least 0.025 cm, and possibly by at least 1 cm, and the tip comprises a pinch point configuration. The adhesive may comprise first and second parts that harden when mixed. Such a fastener can be used to assemble a structure having a composite wall, possibly comprising fiberglass, by providing such a fastener and screwing the fastener into the wall. Such a fastener is particularly advantageous if the structure is a boat.

This application claims the benefit of U.S. provisional application No. 60/429870 tiled “Fastener for Fiberglass” and filed on Nov. 27, 2002, and U.S. provisional application No. 60/508143 titled “Fastener for Fiberglass and Other Composite Structures” and filed on Oct. 1, 2003, each of which is incorporated herein by reference in its entirety.

### FIELD OF THE INVENTION

The field of the invention is fasteners and fastening methods.

### BACKGROUND OF THE INVENTION

Threaded fasteners can readily damage the fiberglass or other composites used in application such as boat building. Among other things, many of the known fasteners can shatter and crack the un-reinforced outer gelcoat surface of the composite, causing it to spall. Additional problems can occur when the rotating threads of the fastener, which are typically non-self tapping sheet metal screws, bore into the fiberglass reinforced plastic composite (FRP), jamming the threads into the bored cavity. This can increase the incidence of “pull-out” caused by reduction in the amount of force required to pull the fastener out of the base material, and in “strip-out” which occurs when the fastener spins freely in the connection.

It is known that these problems can be reduced by pre-drilling or pre-forming a cavity into a FRP composite. In such instances the installer must then use a fastener with a major diameter (the measurement of the greatest outside diameter of the threads), that is only slightly greater than the diameter of cavity. Commonly used sheet metal screws for such applications often have sharp points and type “A” or “AB” threads. Such screws can also have a tapered point and type 25, “B”, rolling or high-low threads, high-low threaded fasteners alternate one high and one low thread along the shank of the fastener. They were originally designed for connections in plastic material to reduce cracking, and are also somewhat effective in improving connections in wood and sheet metal.

Pre-drilling or pre-forming a cavity are not, however, completely satisfactory solutions. In addition to the added manufacturing costs involved, pre-forming limits the amount of load that can be placed on the fastener before pull-out, or torque before spin-out. Additionally, the diameter of the threads can be only slightly larger than the diameter of the cavity formed to avoid shattering or cracking the FRP.

Another common practice is to pre-drill or pre-form a cavity into a FRP composite, and apply an adhesive/sealant (such as 3M® brand 5200 adhesive/sealant) into the cavity. The adhesive properties of the sealant bond the fastener into the cavity, reducing the chance of fastener spin-out and/or pull-out. In addition, the sealant helps to prevent moisture and water from migrating into the cavity.

Although advantageous in many ways, these methods are also problematic. Among other things, the method of applying an adhesive/sealant relies on the adhesive, rather than the mechanical bond of the threads into the wall of the cavity, to reduce fastener pull-out and spin-out. In addition there is no adequate method of determining if a seal has been formed around the entire circumference of the body of the fastener. This is important in the construction of FRP composite structures in the boat building industry, which incorporates foam and balsa cores in its hulls and superstructures. Moisture or water migrating into the area between the outer laminate and the core material will compromise the bond between the two materials, and can cause them to delaminate. In addition, if water is allowed to saturate the core material of the assembly, it can seriously comprise the entire structure, sometimes rendering it unsalvageable. Applying an adhesive into a pre-formed cavity is also labor intensive, requiring multiple steps that once again increase manufacturing costs.

It is known to factory pre-apply a dry adhesive coating or “patch” onto the threads of a fastener, before it is sold to an end-user. Factory pre-applied adhesives are “dry to the touch” contain adhesives and/or sealants that remain dormant until the shearing action of engaging the fastener into a nut or preformed cavity causes them to cure. There are numerous advantages to this approach, including improved resistance to pull-out, vibration. Surprisingly, while this method is widely known in the automotive, aerospace and furniture industries it has apparently never been applied to fasteners used in the assembly of FRP composite structures. Presumably this is because it was not previously appreciated that pre-coating a fastener with a factory pre-applied patch of adhesive and/or sealant would greatly reduce the problems associated with fasteners used in the construction of FRP composite structures. The closest that the prior art comes to pre-coated screws that provide a water-tight, moisture and vapor-proof seal is U.S. Pat. No. 5,260,100 to Day (Nov. 1993). But there, the threads are coated with a liquid or pasty sealant, which is then over coated with a dry, hard material.

What has not been previously appreciated is that sheet metal screws and other fasteners used in the assembly of FRP composite structures, for example in the boat building industry, can advantageously have threads that are factory pre-coated with a dry adhesive.

### SUMMARY OF THE INVENTION

The present invention is directed to threaded fasteners that are adapted to the assembly of FRP composite structures used in boat building (and other industries), and for making attachments to previously assembled FRP composite assemblies. A narrower focus is on threaded fasteners that combine a self-drilling tip that is long enough to assure that drilling action is complete before the first thread engages the FRP surface, with high-low threads that are factory pre-coated with an adhesive and/or sealant such that a water-tight, moisture and vapor-proof seal is formed about the fastener when the fastener is used. Such fasteners are especially advantageous in applications where connections to fiberglass are needed, and leaks resulting from drilling cavities through the fiberglass are problematic.

A preferred threaded fastener has a self-drilling tip and threads holding a substantially dry self-curing adhesive. It is preferred that the tip is distanced from the threads by at least 0.025 cm, and possibly by at least 1 cm. The adhesive is preferably factory pre-applied and is cured after the fastener is driven into the cavity. The fastener may comprise stainless steel, threads that are disposed about a shank, and a load bearing head at an end of the shank, and may comprise a nib disposed on a surface of the head. The fastener may comprise threads that have a high-low configuration. The adhesive may be microencapsulated. Such a fastener can be used to assemble a FRP component structure, and is particularly advantageous if the structure is a boat, airplane, mobile home, or other structure for which water damage is a significant concern.

Pre-coated adhesives and/or sealants preferably lie dormant on the fastener until the shearing action of the threads engaging the composite releases, mixes, activates the substance(s), or in some other manner triggers the curing process. After curing, the adhesive reduces the incidence of fastener pull-out, spin-out and provides a seal around the body of the fastener. In some instances fasteners comprising a factory pre-applied adhesive can even be reused, since some of the adhesive/sealant may remain unactivated when the fastener is first used.

Threaded fasteners having high-low threads with a pitch that is generally twice that of a masonry fastener and a steeper 60 degree included angle thread profile to provide for faster insertion. In addition, the fasteners' deep, coarsely spaced threads provide a high shear area and deeper thread engagement in fiberglass composites, further enhancing holding capabilities.

It should be noted that although the invention disclosed herein is described primarily in relation to threaded fasteners in the form of screws that are cylindrical rods bearing one or more helical or advancing spiral threads that can be driven as a fastener by turning, it is applicable to other fasteners as well, with nails being but one example, but is particularly advantageous when applied to threaded fasteners. It is also equally applicable to different types of threaded fasteners, and, more particularly, to different types of screws. As such, although particularly advantageous when used on self drilling screws having high-low threads used in forming composite structures comprising fiberglass, particularly when such structures are or are coupled to boats, the actual style, shape and dimensions of the fastener will likely vary between embodiments.

As used herein “included angle” is the angle between the flanks, measured in an axial plane section where the flanks of a thread are the straight sides that connect the crest and the root, the crest of a thread is the prominent part of a thread, and the root is the bottom of the groove between the two flanking surfaces of the thread. As used herein the “pitch” of a thread is the distance, measured parallel to its axis, between corresponding points on adjacent surfaces, in the same axial plane. However, pitch may be approximated herein by specifying the number of threads per inch (TPI).

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of a screw embodying the invention.

FIG. 2 is a perspective view of a screw embodying the invention.

FIG. 3A is an end view of a screw embodying the invention.

FIG. 3B is an side view of the screw of FIG. 3A.

FIG. 3C is a detail view of the screw of FIG. 3B.

FIG. 3D is a side view of a screw embodying the invention.

FIG. 4 is a cutaway view of a thread of a screw embodying the invention.

FIG. 5A is a cutaway view of a thread of a screw embodying the invention.

FIG. 5B is a cutaway view of a thread of a screw embodying the invention.

FIG. 5C is a cutaway view of a thread of a screw embodying the invention.

FIG. 5D is a cutaway view of a thread of a screw embodying the invention.

FIG. 5E is a cutaway view of a thread of a screw embodying the invention.

FIG. 6A is a cutaway view of a head of a screw embodying the invention.

FIG. 6B is a cutaway view of a head of a screw embodying the invention.

### DETAILED DESCRIPTION

In FIG. 1, a fastener in the form of a screw 100 has a head 110, a body 120, and a self-drilling tip 130. Head 110 includes bearing surface 111. Body 120 includes cylindrical shank 121 and high and low threads 123 and 122, with threads 111 comprising surface 122A. Threads 122 and 123 are at least partially coated (“hold”) a substantially dry self-curing adhesive (not shown in FIG. 1, but discussed in relation to FIGS. 4-6B).

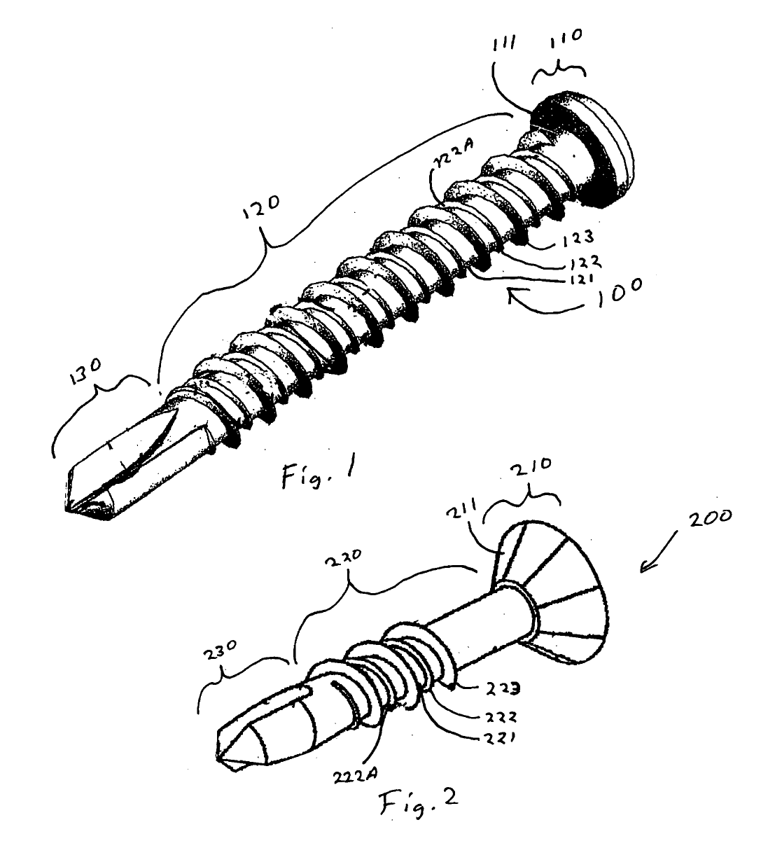

Similarly in FIG. 2, a fastener in the form of a screw 200 has a head 210, a body 220, and a self-drilling tip 230. Head 210 includes bearing surface 11. Body 220 includes cylindrical shank 221 and high and low threads 223 and 222, with threads 211 comprising surface 222A. Threads 222 and 223 hold a substantially dry self-curing adhesive (not shown in FIG. 2, but discussed in relation to FIGS. 4-6B). Screw 200 differs from screw 100 both in regard to the type of head (110, 210) it has, and how much of the shank (121, 221) is covered by threads (122, 123, 222, 223).

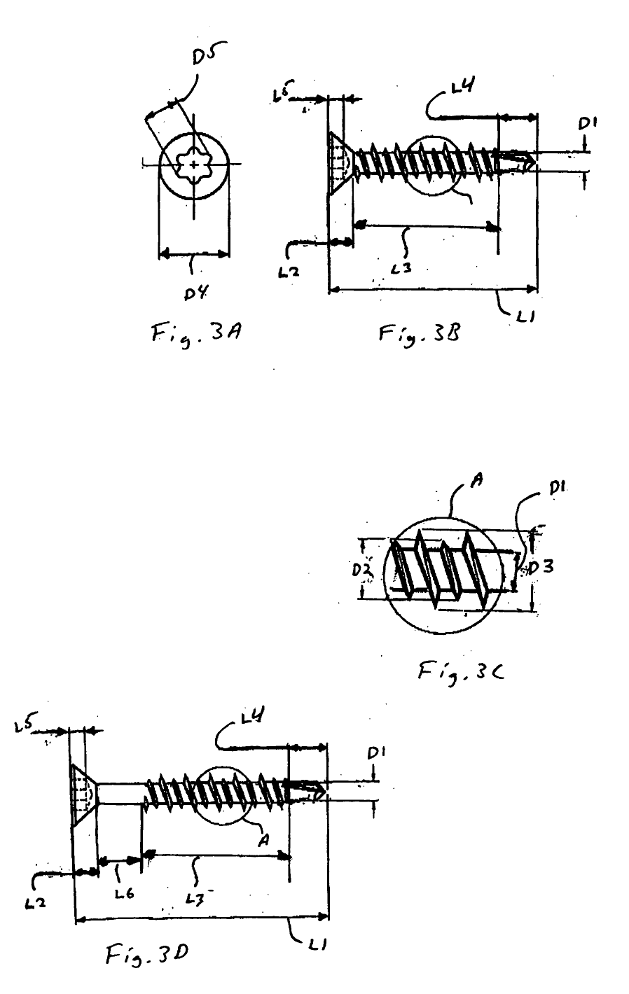

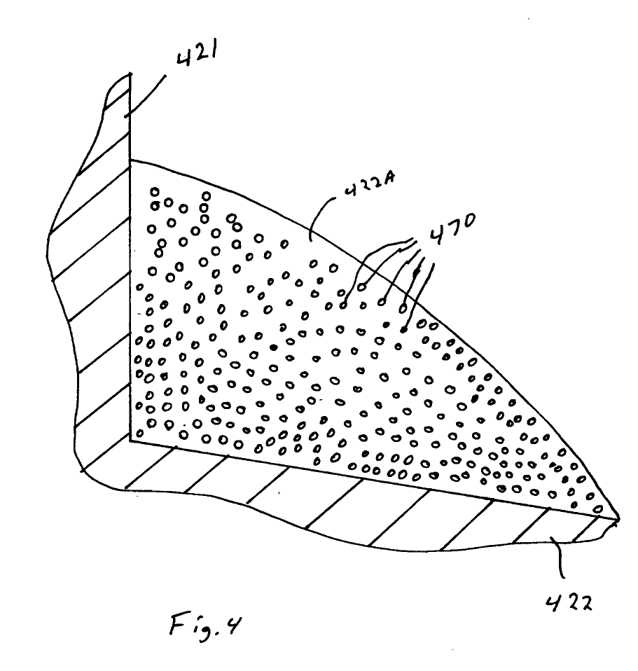

FIGS. 3A-3D illustrate various lengths and diameters of screws 100 and 200 where L1 is the overall length of the screw, L2 is the length/thickness of the head (110, 210), L3 is the length of the threaded portion of the body (120, 220), L4 is the length of the self-drilling tip (130, 230), L5 is the depth of the recess, and for screws which do not have threads extending the entire length of the body between the head (110, 210) and self-drilling tip (130, 230), L6 is the length of the non-threaded portion of body (120, 220), D1 is the diameter of the shank (121, 221) and is sometimes referred to as the minor diameter of the fastener, D2 is the diameter (crest to crest) of the high threads (123, 223) and is sometimes referred to as the major diameter of the fastener, D3 is the diameter (crest to crest) of the low threads (122, 222), D4 is the head outer diameter, and D5 is the diameter of the recess (not shown in FIGS. 1 and 2). Dimensions of corresponding screws in the prior art are already known.

Although the various dimensions will vary between embodiments, it is contemplated that it may be advantageous for an embodiment having threads extending the length of the body to have L1 approximately 2.4 mm, L2 approximately 1.4 mm, L3 approximately 16.65 mm, L4 6.35 mm, L5 approximately 1.4 mm, D1 approximately 3.85 to 3.95 mm, D2 approximately 4.5 to 4.7 mm, D3 approximately 3.8 to 4.0 mm, D4 approximately 7.43 to 8.43 mm, and D5 approximately 3.94 mm.

The tip, shank, threads, and head are preferably made of a material that are corrosion resistant. The presently preferred material is 316 stainless steel. However, alternative may utilize other materials or combinations of materials including but not limited to other forms of stainless steel, zinc plated steel, brass, bronze and plastic.

Fasteners as disclosed herein may comprise any type of head as partially illustrated by the pan head 110 of fastener 100 and the flat head 210 of fastener 200, but preferred heads are flat heads, oval heads, and pan heads. It is contemplated that the choice of heads will vary depending on the fastening application the fastener is intended for. As such, other embodiments may include but is not necessarily limited to flat heads, oval heads, pan heads, round heads, fillister heads, binding heads, holt heads, truss heads, hexagon heads, and acorn heads. It is also contemplated that in applications where a seal is to be formed about the fastener to preserve the integrity of any barrier pierced by the fastener (such as a fiberglass boat hull), the use of a head having a bearing surface that conforms to the shape of the surface it is adjacent to will help in the formation of such a seal.

For fasteners adapted to be countersunk such as flat head fasteners, it is desirable to form nibs extending radially on the bottom side/bearing surface to aid in counter sinking the head in the surface adjacent to the bearing surface. At least four such nibs are preferable, and six nibs are considered to be optimal. Other embodiments may include 4-8 nibs or some other quantity of nibs.

The heads may be shaped, or may include recesses, protrusions, or combinations thereof to facilitate mating the fastener with a driving tool such as a screwdriver to drive the screw. As such, the heads may be adapted to be driven by, among others, Philips, flat blade or Torx drivers and Allen wrenches.

Preferred fasteners having high-low threads (122, 123, 222, 223) are preferred, but alternative embodiments may comprise a single thread, more than two threads, and/or configurations of threads other than high-low threads.

The preferred fastener has high-low threads with a thread pitch that is generally twice that of a masonry fastener and a steeper included angle thread profile. Preferred thread pitches are in the range of 4 to 5 mm (roughly 6 to 5 TPI) for a fastener having a high-thread diameter of 4.5 to 4.7 mm. In some instances thread pitch will be approximately 93% to 97% of the high-thread diameter, and frequently may be about 95%. Included angles of preferred threads are in the range of 50 to 70 degrees, more preferably 55 to 65 degrees, and most preferably 60 degrees. For embodiments having high-low threads, it is contemplated that the included angles of the two threads of a particular embodiment may differ in which case the preferred included angle ranges given are those of the “high” thread, and the preferred-ranges for the low thread are 20 to 40 degrees, more preferably 25 to 35 degrees, and most preferably 30 degrees. Doubling the pitch (decreasing the TPI) results in a thread profile that makes the fastener twice as fast as others found in prior art. In addition, the fasteners' deep, coarsely spaced threads provide a high shear area and deeper thread engagement in fiberglass composites, further enhancing holding capabilities.

Any threads (122, 123, 222, 223) may extend along the entire length of the body of the fastener as shown by threads 122, 123 of body 120 of fastener 100, or may extend only along a portion of the length as shown by threads 222, 223 of body 220 of fastener 200. Having the threads extend only part way along the body of a fastener helps prevent jacking, i.e. a top piece of material pulling away from a base material by fastener threads in the top material forcing the top material up the body of the fastener.

Drilling tip 130 is preferably a self-drilling fluted point adapted to drill completely through the fiberglass composite or other composite material before the high-low self-tapping threads (122, 123, 222, 223) engage it, preventing pull-through and assuring a good connection. It is contemplated that it is advantageous to have the tip distanced from the threads by at least 0.5 cm, and more preferably by at least 1 cm. Especially preferred screws also have a self-drilling tip with a flute and a length between ¼″ and ⅜″ to assure that the drilling action is complete before the first thread engages the composite it is drilling into. Drilling tip 130 preferably comprises a pinch point configuration. Alternative embodiments may comprise some other form of self-drilling tip.

The preferred fastener employs threads at least partially pre-coated with a microencapsulated, room temperature curing sealant designed to be coated on a fastener and dried, and to remain dormant until the shearing action of engaging the fastener into a nut or threaded cavity breaks the capsules and allows the adhesive to cure. The pre-applied adhesive sealant is preferably Scotch-Grip™ Fastener Adhesive 2353, marketed by the 3M™ Company. In some embodiments the adhesive may comprise two or more parts separately encapsulated that harden when mixed.

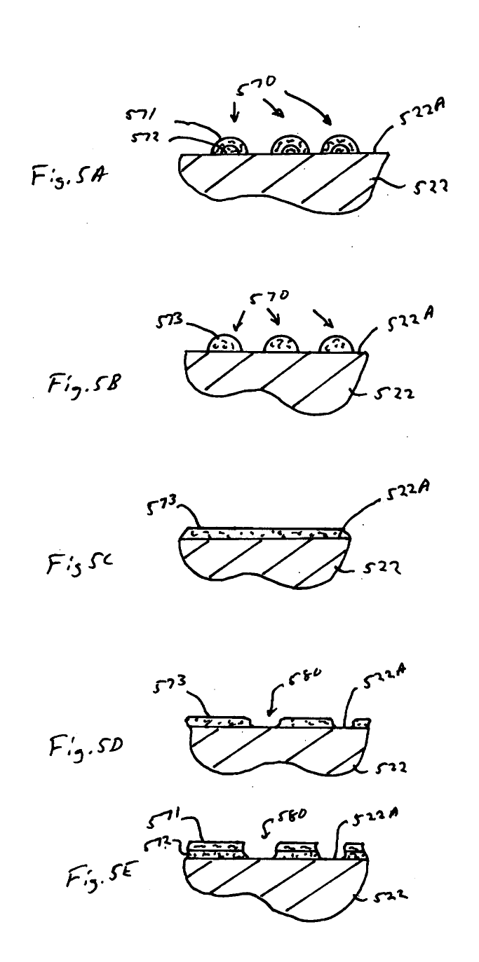

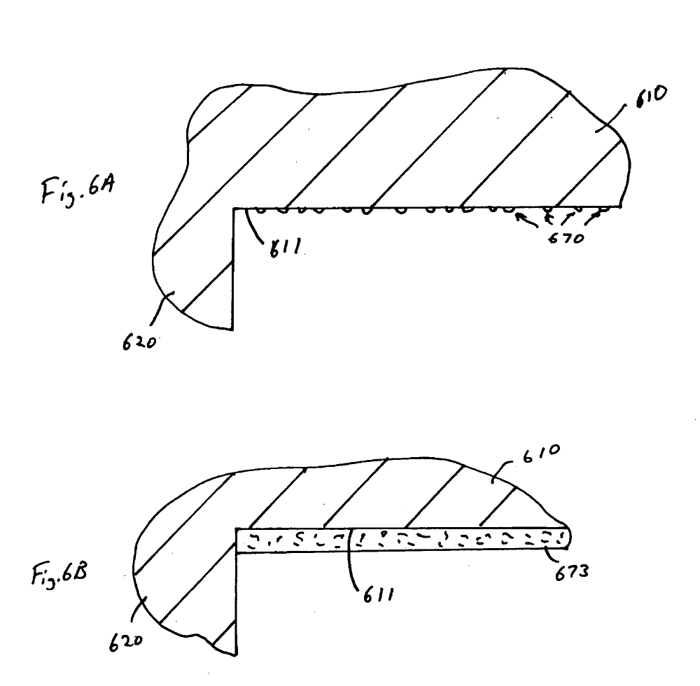

As used herein, the term “microencapsulate” means to enclose in microcapsules where a “microcapsule” is a small, sometimes microscopic capsule designed to release its contents when broken by pressure, dissolved, or melted. FIG. 4 illustrates the surface of a fastener comprising a shank 421, a thread 422, a thread surface 422A and a plurality of microcapsules 470. It is contemplated that the microcapsules in some instances will be distinct units as shown in FIG. 4 and FIGS. 5A and 5B while in other instances the may be part of a covering layer that fully or partially covers surface 422A as shown in FIGS. 5C-5E. In some instances the microcapsules (in individual or layered form) may consist essentially only of the sealant as illustrated by FIGS. 5B-5D, or may comprise a sealant at least partially encapsulated by another material as illustrated by FIGS. 5A and 5E. In FIG. 5A, sealant 572 is encapsulated by material 571 in microcapsules 570 on surface 522A of a thread 522. In FIG. 5B, sealant 573 forms 570 on surface 522A of a thread 522. In FIG. 5C, layer 573 comprise sealant microcapsules on surface 522A of a thread 522. In FIG. 5D, the layer 573 of FIG. 5C is non-continuous as it contains or more exposed regions 580. In FIG. 5E sealant 572 is partially encapsulated by material 571 but is non-continuous so leaves-exposed areas 580 of surface 522A.

Although it is preferred that the threads be coated with sealant as illustrated by FIG. 4, it is contemplated that other portions of the fastener may be coated in addition to or in place of the coating on the thread surfaces. As such the shank may be coated and/or the bearing surface of the head may be coated as illustrated by FIGS. 6A and 6B. In FIGS. 6A and 6B, bearing surface 611 of head 610 attached to shank 620 is coated with microcapsules that are either distinct units 670 as shown in 6A, or in a layer 673 as shown in FIG. 6B.

In alternative embodiments the pre-applied dry coating could have little or not adhesive properties. A composition that is primarily a sealant would still be a significant benefit over the prior art.

It is contemplated that the various fastener features disclosed herein may be comprised in any combination. As such, some fastener may comprise a body having a single thread coated with sealant and having a self-drilling tip wherein others may comprise high-low threads coated with sealant but not having a self-drilling tip.

Fasteners as disclosed herein may be advantageous used in numerous applications. However, it is contemplated that they may be most advantageously used then fastening items formed from composite materials such as fiberglass to other objects or fastening objects to items from composite materials such as fiberglass. As such, a method of assembling a structure having a composite wall may comprise providing a threaded fastener as described herein and screwing the fastener into the wall. The wall may be fiberglass and the structure may comprise a boat.

It is contemplated that fasteners as described herein may be advantageously used to form a cavity in a composite barrier, insert portions of itself into the walls of the cavity thus formed, and, in conjunction with a pre-coated with a microencapsulated, room temperature curing sealant to form a water-tight, moisture and vapor-proof seal to prevent water/moisture from migrating into or through the composite barrier via the cavity formed. In preferred methods, the fastener will comprise a pan or flat head, self-drilling, high-low threaded screw having threads at least partially coated with Scotch-Grip™ Fastener Adhesive where one such thread has an included angle of 60 degrees and a pitch of 4 to 5 mm. In some applications this method will be used to fasten something to a fiberglass hull, deck, wall or other barrier of a boat.

Thus, specific embodiments and applications have been disclosed for a fastener for fiberglass, in which the threads are precoated with a dry adhesive sealant. It should be apparent, however, to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A threaded fastener having a self-drilling tip and threads holding a substantially dry self-curing adhesive.

2. The fastener of claim 1 wherein the tip is distanced from the threads by at least 0.5 cm.

3. The fastener of claim 1 wherein the tip is distanced from the threads by at least 1 cm.

4. The fastener of claim 1 wherein the tip comprises a pinch point configuration.

5. The fastener of claim 1 wherein the adhesive is microencapsulated.

6. The fastener of claim 1 wherein the adhesive comprises first and second parts that harden when mixed.

7. The fastener of claim 1 wherein the threads comprise stainless steel.

8. The fastener of claim 1 wherein the threads are disposed about a shank, and further comprising a load bearing head at an end of the shank.

9. The fastener of claim 8 wherein further comprising a nib disposed on a surface of the head.

10. The fastener of claim 1 wherein at least a portion of the threads has a high-low configuration.

11. The fastener of claim 1 wherein the adhesive is microencapsulated, and at least a portion of the threads has a high-low configuration.

12. The fastener of claim 1 wherein the tip is distanced from the threads by at least 0.5 cm, and the adhesive is microencapsulated, and at least a portion of the threads has a high-low configuration.

13. A method of assembling a structure having a composite wall, comprising:
providing a threaded fastener according to claim 1; and
screwing the fastener into the wall.

14. A method of assembling a structure having a composite wall, comprising:
providing a threaded fastener according to claim 11; and
screwing the fastener into the wall.

15. The method of claim 14 wherein the wall comprises fiberglass.

16. The method of claim 14 wherein the structure comprises a boat.

17. A method of assembling a structure having a composite wall, comprising:
providing a threaded fastener according to claim 12; and
screwing the fastener into the wall.
